(19) United States
(12) Patent Application Publication
(10) Pub. No.: US 2026/0323135 A1
(43) Pub. Date: Oct. 15, 2026

(54) AI SYSTEM FOR ENHANCING MEDIA ACCESSIBILITY VIA NON-VERBAL SOUND SUBTITLING

(71) Applicant: Pedro Miguel Alves Neves, London (GB)

(72) Inventor: Pedro Miguel Alves Neves, London (GB)

(21) Appl. No.: 19/177,512

(22) Filed: Apr. 12, 2025

(51) Int. Cl. H04N 21/84; G06F 40/58

(52) U.S. Cl. CPC H04N 21/84; G06F 40/58

(57) ABSTRACT

This invention discloses a system for enhancing subtitle generation using deep learning to detect, classify, and annotate non-verbal sound events in multimedia content. By identifying sounds such as applause, alarms, and laughter, the system improves accessibility for hearing-impaired users and enhances overall viewer experience. It supports real-time and batch processing, multilingual compatibility, and flexible integration via SDKs and APIs.

### EMBODIMENTS AND USE CASES

The invention may be embodied in various forms, with specific implementations providing particular advantages depending on context:

### Embodiment 1: Streaming Platforms Integration

A browser extension or plugin embodiment can be deployed with platforms like Netflix or YouTube. When users stream content, the extension detects non-verbal sounds and overlays real-time subtitles with appropriate annotations, improving accessibility without requiring modification to the original media.

### Embodiment 2: Post-Production Tool for Content Creators

A GUI desktop or web-based application allows video editors to upload their media, configure genre-specific sound profiles, and download subtitle files enriched with labeled non-verbal events. This use case is particularly suited for documentary or educational content.

### Embodiment 3: Live Broadcasting Enhancer for Accessibility

Real-time subtitle generation for live events such as news broadcasts, conferences, or webinars. Integrated into the broadcasting system via an API, it detects on-the-fly audience reactions (e.g., applause, booing), environmental cues, or alarms, which are translated and rendered as subtitles in multiple languages.

### FIELD OF THE INVENTION

The invention utilizes deep learning models to automatically detect, classify, and annotate non-verbal sound events in multimedia content, enhancing subtitle generation and accessibility for hearing-impaired users by providing synchronized metadata such as sound type and duration.

### BACKGROUND OF THE INVENTION

The current landscape of subtitle generation largely focuses on transcribing spoken dialogue, often neglecting the inclusion of non-verbal sound events such as applause, laughter, alarms, and various environmental noises. These auditory cues are essential for conveying the full emotional tone, context, and atmosphere embedded within multimedia content. For hearing-impaired viewers, the absence of these sounds in subtitles significantly limits their understanding and enjoyment, preventing them from fully immersing in the experience the content intends to offer.

Traditional methods of manually annotating non-verbal sound events are time-consuming, resource-intensive, and impractical for large-scale implementation. These approaches are often inconsistent and lack the accuracy required to meet the demands of modern media production. Current automated subtitle solutions tend to prioritize spoken dialogue, often overlooking other critical auditory cues, which leads to the inadequate detection and classification of non-verbal sounds. As a result, these systems fail to provide a complete sensory experience, leaving hearing-impaired users with an incomplete understanding of the content, thus undermining the original intention of the creators.

There is a growing need for an AI-driven system capable of seamlessly integrating the detection and classification of non-verbal sound events into existing subtitle generation frameworks. A scalable, efficient solution is required to automatically process these sounds and incorporate them into subtitles across diverse formats and delivery platforms. Such a solution would not only improve accessibility for hearing-impaired users but would also enhance the content experience for all viewers by preserving vital contextual and emotional cues that enrich the narrative.

This invention addresses these challenges by providing a comprehensive system that employs advanced deep learning models to detect, classify, and annotate non-verbal sound events. By doing so, it transforms how multimedia content is made accessible, ensuring a more inclusive and immersive experience for all viewers, while significantly improving user engagement and satisfaction.

### SUMMARY OF THE INVENTION

The present invention introduces a transformative system and method that revolutionizes subtitle generation by focusing on the detection, classification, and annotation of non-verbal sound events-such as applause, laughter, alarms, and environmental noises-within multimedia content. While current technologies predominantly focus on transcribing spoken dialogue, they often overlook these vital non-verbal auditory cues, which contribute significantly to the emotional tone and atmosphere of the content. This invention aims to fill this critical gap, ensuring that the full context, emotional depth, and sensory experience of the content are accurately conveyed.

Leveraging advanced deep learning models, the system is trained on diverse, high-quality open-source datasets like Audio Set to precisely identify and classify a wide array of non-verbal sound events. It generates detailed metadata for each identified sound event, including sound type, duration, intensity, and exact timestamps. These metadata are synchronized with the video content, enabling the seamless integration of non-verbal sounds into subtitles. This not only enhances accessibility for hearing-impaired users but also enriches the viewing experience for all audiences by providing greater context and depth.

Key features of the invention include real-time subtitle generation and batch processing capabilities, catering to both live broadcasts and pre-recorded content. This flexibility supports a broad range of applications, ensuring that critical non-verbal sound events are accurately highlighted within subtitles. This capability significantly enhances the inclusivity and immersive quality of the content, offering a richer, more comprehensive viewing experience.

The system is designed with multilingual support, allowing for the generation of subtitles in multiple languages. Its modular architecture facilitates integration via Software Development Kits (SDKs), Application Programming Interfaces (APIs), and Graphical User Interfaces (GUIs), offering developers and content creators a range of deployment options suited to their specific needs.

The invention is also designed with adaptability in mind, allowing for future enhancements and expansions. Potential advancements could include modules for emotion detection and spatial sound analysis, further enhancing the system's ability to convey complex auditory and emotional cues. This adaptability ensures that the system can evolve alongside technological advancements, maintaining its relevance and effectiveness in a rapidly changing digital landscape.

In summary, this invention provides a scalable and robust solution to a critical gap in existing subtitle technologies. By focusing on non-verbal sound events, the system not only improves accessibility for hearing-impaired users but also enhances the overall quality and immersion of multimedia content. This innovative approach to subtitle generation has the potential to redefine how multimedia content is accessed, understood, and enjoyed, benefiting a wide range of global audiences.

### DESCRIPTION OF THE DRAWINGS

The drawings outlined in the numbered paragraphs provide a detailed visual representation of the system and its processes:

FIG. 1 is a block diagram illustrating the architecture of the AI-based subtitle enhancement system, including Input Section (110), Development Options (120), AI Processing Engine (130), Output Section (140), and Subtitle Formats (150).

FIG. 2 is a flow diagram showing the standard media upload and subtitle generation workflow, including steps 210-280.

FIG. 3 is a diagram comparing batch versus real-time subtitle processing workflows, including steps 310-380.

FIG. 4 is a flowchart of the real-time live stream subtitle enhancement pipeline, including steps 410-490.

FIG. 5 is a schematic depicting multilingual annotation processing for cross-language accessibility, including steps 510-570.

These figures collectively offer insights into the system's components, workflows, and multilingual capabilities, illustrating the comprehensive scope of the invention.

### DETAILED DESCRIPTION OF THE INVENTION

The present invention discloses an innovative system designed to enhance the quality, depth, and accessibility of subtitles in multimedia content through the autonomous detection, classification, and annotation of non-verbal sound events.

While traditional subtitle systems primarily focus on transcribing spoken dialogue, this invention extends the scope of subtitle content by including critical auditory cues—such as applause, laughter, alarms, ambient environmental sounds, and other non-speech elements—that are essential to accurately conveying the emotional and contextual experience of audiovisual media.

By incorporating these non-verbal sound events into subtitles, the invention significantly improves accessibility for hearing-impaired individuals, while simultaneously enriching the content experience for all users. At its core, the system leverages advanced artificial intelligence models, specifically deep learning techniques, to perform real-time or batch processing of audio streams embedded in video files. The result is a comprehensive and context-aware subtitle output that reflects not only what is said but also what is heard.

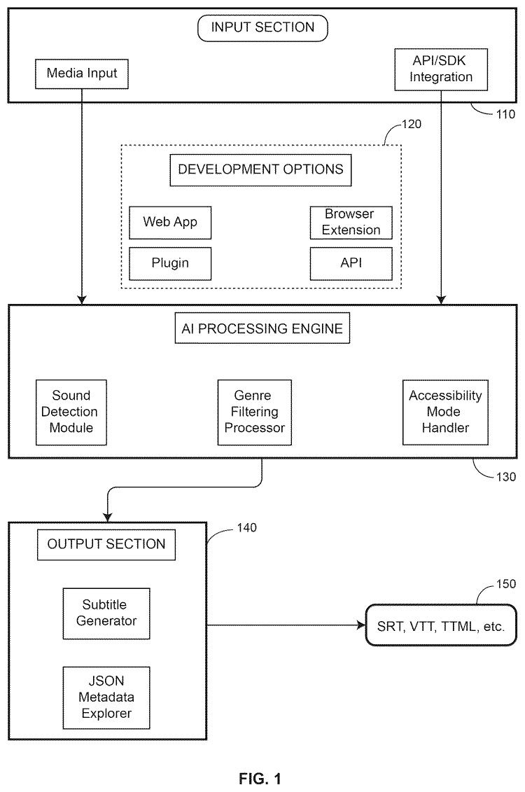

Referring to FIG. 1, the invention comprises a modular architecture that includes the following core components:

### Input Section (110)

This module functions as the system's ingestion point for multimedia files. It supports a wide array of industry-standard formats, including but not limited to MP4, MOV, AVI, and MKV. It ensures broad compatibility with various content creation and distribution platforms, enabling seamless integration across different media pipelines.
(a) Development Options (120): To maximize flexibility and deployment scalability, the system offers multiple integration paths tailored for different use cases:
(b) Web Application (121): A user-friendly interface for individuals or institutions to upload and process content directly online.
(c) Browser Extension (122): Enables real-time subtitle enhancement during video playback in supported browsers.
(d) Software Plugin (123): Designed for use within video editing tools or media players to allow native processing.
(e) REST API (124): Allows enterprise-level integration, enabling backend automation and batch processing for high-volume workflows.

### AI Processing Engine (130):

This is the computational core of the system and consists of three intelligent sub-modules:
(a) Sound Detection Module (131): Employs convolutional neural networks (CNNs) and recurrent neural networks (RNNs), trained on curated datasets such as Google's AudioSet, to accurately detect a broad range of non-verbal sound events. The model is capable of extracting acoustic features from time-frequency representations to improve detection performance in diverse audio environments.
(b) Genre Filter Processor (132): Allows users to apply contextual filters based on the content's genre (e.g., film, documentary, educational, news). This contextual tuning enhances model sensitivity and reduces false positives by narrowing the range of expected sound events.
(c) Accessibility Mode Handler (133): Prioritizes the annotation of sound events based on urgency and relevance. It dynamically adjusts subtitle formatting (e.g., font size, color, or placement) to emphasize critical events like alarms, sirens, or sudden impacts, thereby improving readability and effectiveness for hearing-impaired viewers.

### Output Section (140):

Once processing is complete, the system generates a dual-layer output:
(a) Subtitle Generator (141): Automatically produces subtitle files containing both dialogue and annotated sound events.
(b) JSON Metadata Explorer (142): Outputs a detailed metadata file that includes event type, duration, confidence score, and time stamps. This file is valuable for analytics, adaptive playback systems, and post-production editing.

Subtitle Formats (150): The system supports a variety of subtitle export formats, including SubRip (SRT), WebVTT (VTT), and Timed Text Markup Language (TTML). This ensures that the output is compatible with major media players, broadcasting systems, and online streaming services.

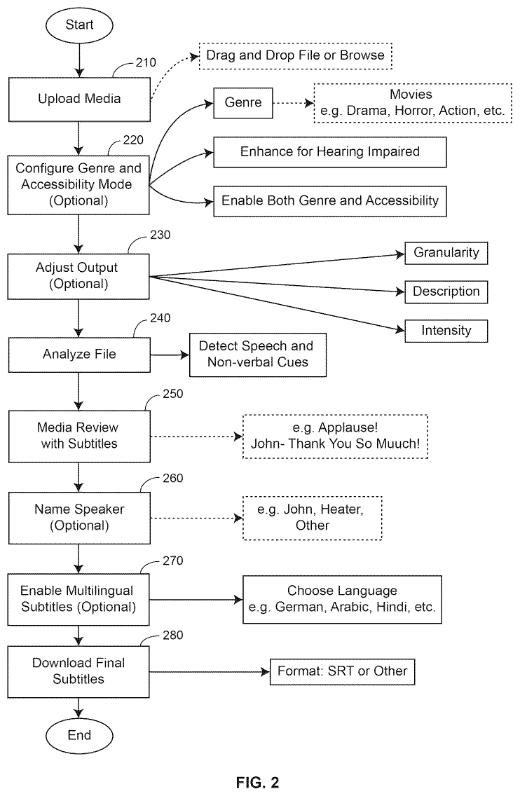

Referring now to FIG. 2, the operational workflow begins when a user submits audiovisual content via the Input Section (110). The AI Processing Engine (130) ingests the audio track, isolates and classifies non-verbal sound events, and maps them to corresponding visual timecodes. These annotations are then embedded within the subtitle files through the Subtitle Generator (141). The JSON Metadata Explorer (142) simultaneously generates a structured data output for optional use in downstream applications or for audit and review purposes.

After processing, the user may select from the available subtitle formats (150), which are rendered with customizable visual parameters according to user preferences or platform requirements. The resulting subtitles, now enriched with contextual non-verbal sound annotations, can be directly integrated into video content or uploaded to hosting platforms for immediate accessibility improvements.

This comprehensive AI-powered solution not only addresses the gaps in conventional subtitle systems but also establishes a scalable, cross-platform framework for inclusive media delivery in a rapidly evolving digital landscape.

AI Processing Engine (130) the core component of the system, the AI Processing Engine, includes three sub-modules. Sound Detection Module (131) Utilizes deep learning models to identify and classify non-verbal sound events from audio streams. Trained on large-scale datasets like Audio Set, the module is optimized to detect a wide range of sounds while ensuring high accuracy.

Genre Filter Processor (132) Allows users to customize the processing based on the content genre (e.g., Movies, Documentary, News) to enhance detection specificity by focusing on genre-relevant sounds. Accessibility Mode Handler (133) prioritizes critical sound events, adjusting subtitle annotations based on urgency and relevance to enhance accessibility for users with hearing impairments.

Output Section (140) following processing, the system generates subtitles with the help of the Subtitle Generator (141). It also includes a JSON Metadata Explorer (142) for users who require detailed sound event data in metadata format.

Subtitle Formats (150) the system supports output in multiple subtitle formats, such as SRT, VTT, and TTML, offering compatibility with various media players and platforms.

According to FIG. 2 the media workflow involves several steps to ensure a seamless and user-friendly experience. Upload Media (210) users upload media files through the Web App or Browser Extension. The system supports a variety of formats, ensuring flexibility for different use cases.

Configure Genre and Accessibility Mode (220) users can specify the genre of the content and enable accessibility modes. These configurations tailor the processing algorithms to better detect and prioritize sounds relevant to the selected genre.

Adjust Output (230) users have the option to fine-tune subtitle rendering settings, adjusting parameters such as the granularity of annotations, description depth, and sound intensity emphasis.

Analyze File (240): The sound detection module processes the media file, isolating speech and non-verbal cues. The system leverages deep learning to accurately identify and categorize these sound events.

Media review with subtitles (250) once processing is complete, users can review the media with overlaid subtitles, including non-verbal annotations like “Applause!” or “Laughter.”

Name Speaker (260) users have the opportunity to manually assign names to speakers within the content, providing additional context and personalization to the subtitle output.

Enable multilingual subtitles (270) the system supports multilingual output, allowing users to select target languages for translation, such as German or Hindi. This expands accessibility and comprehension across diverse language groups.

Download final subtitles (280) users can download the finalized subtitles in their chosen format (e.g., SRT), ready for integration with the original media.

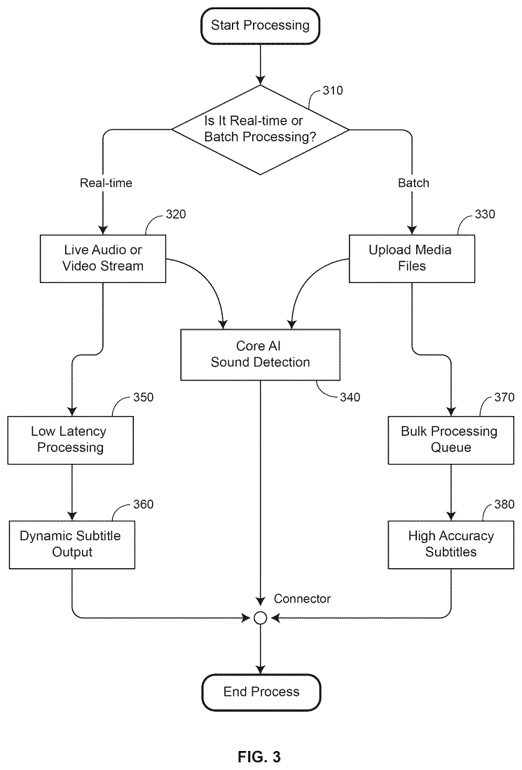

According to FIG. 3 the system accommodates both real-time and batch processing methodologies. Is Real-time or Batch Processing? (310) users choose the processing mode based on their needs—real-time for live content or batch for pre-recorded media.

Live audio or video stream (320) for real-time processing, media is ingested live, ensuring minimal latency in subtitle generation. Upload Media Files (330) in batch mode, media files are uploaded for queued processing, suitable for content libraries or archives.

Core AI sound detection (340) the sound detection module functions in both modes, applying the same robust classification and annotation processes. Low latency processing (350) real-time mode prioritizes speed, producing immediate subtitle outputs for live broadcasts.

Dynamic subtitle output (360) in real-time processing, subtitles are dynamically generated and updated to reflect concurrent audio streams, providing an accurate and timely viewing experience.

Bulk processing queue (370) for batch mode, the system arranges files in a processing queue, allowing for the scalable handling of large volumes of media content.

High accuracy subtitles (380) batch processing focuses on maximizing subtitle accuracy and detail, beneficial for content where precision is more critical than speed.

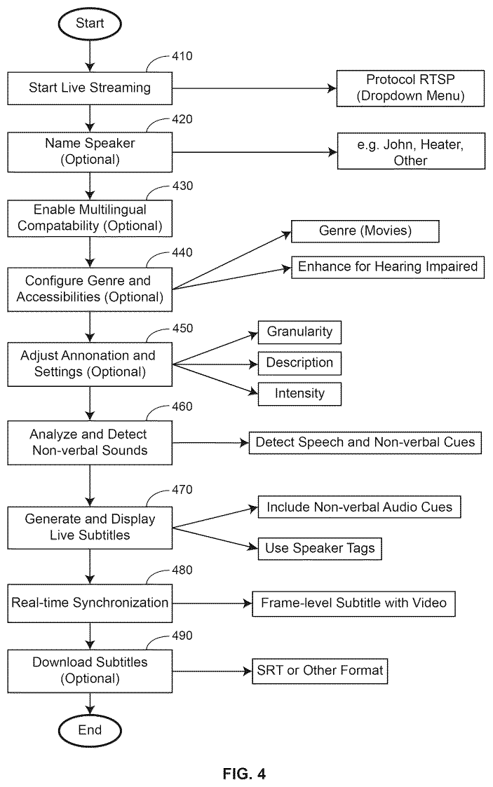

Referring to FIG. 4 the system is well-suited for augmenting live broadcasts with enriched subtitles. Start live streaming (410) users initiate a live stream using widely-supported protocols like RTSP.

Name speaker (420) similar to the standard workflow, users may assign names to speakers during live events, adding clarity to the subtitles. Enable multilingual compatibility (430) multilingual support can be activated, allowing live subtitles to be generated in multiple languages simultaneously.

Configure genre and accessibility (440) users select settings related to the content genre and accessibility priorities, tailoring the subtitle enrichment to the context of the broadcast. Adjust annotation settings (450) annotation parameters can be customized in real-time, enabling on-the-fly adjustments to how sound events are labeled and displayed.

Analyze and detect non-verbal sounds (460) the sound detection module operates in real-time, continuously categorizing non-verbal sounds as they occur in the stream. Generate and display live subtitles (470) the system actively generates subtitles that are synchronized with the live audio and video, ensuring accurate representation of both verbal and non-verbal content.

Real-time synchronization (480) subtitles are aligned with video frames at the millisecond level, ensuring seamless integration with the visual content. Users can download a record of the live-generated subtitles post-broadcast, available in their format of choice.

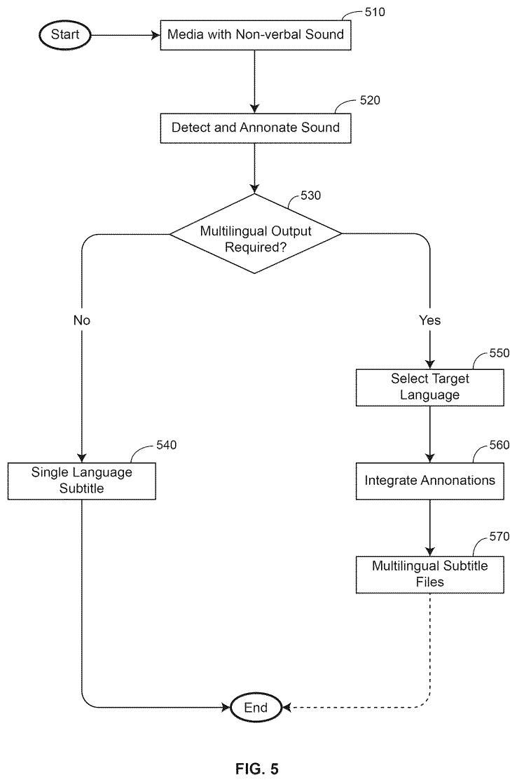

According to FIG. 5 the system's capacity for multilingual processing expands content reach across global audiences. Media with Non-verbal Sound (510) the system processes media inherently containing non-verbal sound events. Detect and Annotate Sound (520) non-verbal sounds are identified and annotated with contextually relevant descriptions.

Multilingual output required (530) the system determines whether multilingual subtitles are needed, guiding the subsequent processing steps. Single language subtitle (540) if multilingual output is not required, the system generates subtitles in the original language, incorporating non-verbal sound annotations.

Select target language (550) users select the desired target languages for subtitle translation, enabling cross-language accessibility of multimedia content. Integrate annotations (560) non-verbal sound annotations are translated and integrated into the subtitles, preserving the original context and meaning (e.g., translating [LAUGHTER] to [RISAS] in Spanish).

Multilingual subtitle files (570) the system outputs properly formatted subtitle files in multiple languages, ready for international distribution and consumption.

The invention's system is implemented using state-of-the-art machine learning frameworks, including TensorFlow. A customized version of the YAM Net audio event classification model, based on Mobile Net architecture, has been fine-tuned on domain-specific subsets of large-scale datasets like Audio Set. This customization significantly enhances the accuracy of detecting and classifying non-verbal sound events relevant to the scope of multimedia accessibility, such as applause, laughter, alarms, various environmental sounds, and even emotional cues.

Both cloud and edge computing environments benefit from the optimized AI model, which supports GPU and TPU acceleration to maintain scalable performance. The system can be deployed through modern containerized services, such as Docker, orchestrated by Kubernetes across popular cloud platforms like AWS, GCP, or Azure.

System access is facilitated via RESTful APIs and WebSocket streams, with integration capabilities through modular interfaces, including a Web App, Browser Extensions, and Plugins for professional non-linear editing software like Adobe Premiere and Da Vinci Resolve. These interfaces enable a flexible approach to real-time and batch-mode subtitle enhancement, configurable according to genre, annotation granularity, and accessibility prioritization.

The architecture's modular design allows for future enhancements, such as emotion detection, spatial audio annotations, or semantic audio tagging, without disrupting the core functionality involved in subtitle enhancement. This forward-compatible structure ensures longevity and adaptability as new technological needs and opportunities arise.

In conclusion, embracing this AI-driven subtitle enhancement system is projected to yield substantial operational advantages, such as a reduction in costs and processing times, by automating non-verbal sound detection and annotation, streamlining multimedia production, and enhancing accessibility services.

1. A method for enhancing subtitle generation in multimedia content by detecting and annotating non-verbal sound events, the method comprising detecting and classifying non-verbal sound events in audio streams using deep learning models; synchronizing the detected sound event annotations with corresponding video content to generate enriched subtitle files; and extracting and embedding metadata associated with each sound event, including sound type, duration, intensity, and timestamps aligned with the video content.

2. The method of claim 1, wherein the deep learning models comprise convolutional neural networks (CNNs) trained on labeled datasets including AudioSet.

3. The method of claim 1, wherein subtitle formatting dynamically adapts based on the urgency, intensity, or semantic importance of the detected sound events to enhance accessibility for hearing-impaired users.

4. The method of claim 1, further comprising translating the generated subtitle annotations into one or more target languages using a neural machine translation engine.

5. The method of claim 1, further comprising allowing users to edit, approve, or reject the automatically generated sound annotations prior to subtitle export.

6. The method of claim 1, wherein the metadata associated with the sound events is stored in a structured format for downstream analytics or adaptive playback systems.

7. A system for generating enriched subtitles through the detection and annotation of non-verbal sound events in multimedia content, the system comprising an input interface configured to receive multimedia content; a processing engine comprising deep learning models for identifying and classifying non-verbal sound events; a subtitle generation module configured to synchronize and embed sound event annotations and associated metadata into subtitle formats; and an output module supporting multiple subtitle formats compatible with various playback environments.

8. The system of claim 7, wherein the processing engine supports both real-time subtitle generation for live media and batch processing for pre-recorded content.

9. The system of claim 7, wherein the subtitle generation module allows for customizable formatting including text size, font color, and positioning based on user preferences or sound event type.

10. The system of claim 7, further comprising an application programming interface (API) for integration with third-party platforms such as media players, editing software, or content delivery networks.

11. The system of claim 7, wherein the processing engine includes a genre-based configuration module that adjusts sound classification thresholds depending on the selected media category.

12. The system of claim 7, further comprising a multilingual engine configured to generate subtitle outputs in two or more target languages concurrently.

13. A non-transitory computer-readable medium storing instructions that, when executed by one or more processors, cause the system to detect and classify non-verbal sound events in audio streams using neural network-based models; synchronize detected events with visual frames in multimedia content; generate subtitle files with embedded metadata including sound type, duration, and timestamps; and translate subtitle annotations into multiple target languages using a neural machine translation system.

14. The computer-readable medium of claim 13, wherein the instructions include logic for identifying content genre and dynamically adjusting sound detection parameters accordingly.

15. The computer-readable medium of claim 13, wherein the instructions further allow for cultural and contextual adaptation of sound event translations across different target languages.

16. The computer-readable medium of claim 13, further comprising instructions for exporting subtitle files in at least one of the following formats: SubRip (SRT), WebVTT (VTT), or Timed Text Markup Language (TTML).
